(19) United States
(12) Patent Application Publication
(10) Pub. No.: US 2003/0188553 A1
(43) Pub. Date: Oct. 9, 2003

(54) Direct bonding methods using lithium

(76) Inventors: Larry G. Mann, Painted Post, NY (US); Robert Sabia, Corning, NY (US); Dennis W. Smith, Corning, NY (US)

Correspondence Address: CORNING INCORPORATED, SP-TI-3-1, CORNING, NY, 14831

(21) Appl. No.: 10/118,780

(22) Filed: Apr. 8, 2002

(51) Int. Cl. C03C 15/00

(52) U.S. Cl. 65/30.1

(57) ABSTRACT

Methods of improving the direct bonding of articles are disclosed. Lithium can be incorporated into the composition of one of the articles and/or lithium can be added to a bonding surface by ion exhchange, absorption, ion implantation, coating, or deposition. Bonding is achieved without use of adhesives or high temperature fusion. The invention is useful for bonding a wide variety of articles together such as optical components, optical fibers and articles having different coefficients of thermal expansion or refractive indices.

### FIELD OF THE INVENTION

This invention relates to direct bonding. More particularly, the invention relates to methods for improvement of direct bonding of surfaces by incorporating lithium into at least one of the surfaces.

### BACKGROUND OF THE INVENTION

The formation of a direct chemical bond between two glass or metal surfaces allows for an impermeable seal that has the same inherent physical properties as the bulk material being bonded. In literature, low-temperature bonding technology has been reported for bonding soda-lime-silicate glass and for crystalline quartz (see, e.g., A. Sayah, D. Solignac, T. Cueni, “Development of novel low temperature bonding technologies for microchip chemical analysis applications,” Sensors and Actuators, 84 (2000) pp. 103-108 and P. Rangsten, O. Vallin, K. Hermansson, Y. Backlund, “Quartz-to-Quartz Direct bonding,” J. Electrochemical Society, V. 146, N. 3, pp. 1104-1105, 1999). Both the Sayah and Rangsten references disclose using acid to contact the bonding surfaces. Another article, H. Nakanishi, T. Nishimoto, M. Kani, T. Saitoh, R. Nakamura, T. Yoshida, S. Shoji, “Condition Optimization, Reliability Evaluation of SiO2-SiO2 HF Bonding and Its Application for UV Detection Micro Flow Cell,” Sensors and Actuators, V. 83, pp. 136-141, 2000, discloses low-temperature bonding of fused SiO₂ by first contacting the bonding surfaces with hydrofluoric acid. While these bonding processes are useful for certain applications, the bond strength could be improved.

It would be desirable to provide chemical bonding methods that provide improved bond strength, particularly in systems that include polymers that can not withstand the high temperatures (e.g., exceeding 200° C.) required by fusion bonding. In addition, it would be advantageous to provide bonding methods for glass and silicon-containing articles that do not require adhesives or temperatures near the softening temperature of the articles to be bonded.

### SUMMARY OF THE INVENTION

Some embodiments of the invention relate to a method of bonding surfaces, wherein at least one of the surfaces includes silicon. These embodiments include the steps of including lithium on at least a portion of one of the surfaces and placing the surfaces directly in contact in the absence of an adhesive and at a temperature below the softening point of the surfaces. In certain embodiments, the temperature during bonding is below about 400° C., but according to some embodiments of the present invention, bonding can occur below about 200° C., and in other embodiments, bonding can occur at room temperature. Surfaces that include silicon include but are not limited to ceramic materials, glass materials, or glass-ceramics. As used herein, the term surface may include an exterior portion of a body or an article, or alternatively, the term may refer to an exterior coating or layer on an exterior portion of an article. In some embodiments, the inclusion of lithium on the surface of at least one of the articles results in bond strength between the surfaces of over about 90 pounds per square inch.

Lithium can be included in or on at least one of the surfaces of the articles in several ways. In embodiments in which one of the surfaces includes a glass, lithium can be incorporated in the composition of the glass. In certain embodiments that include a glass surface, the glass surface may include other alkali elements such as, for example, sodium and/or potassium. In these embodiments, lithium can be included in the glass surface by exchanging lithium ions with the alkali ions. Ion exchange may be achieved by contacting the glass surface with a mixture containing lithium. In certain embodiments, the mixture includes a lithium salt, such as for example, lithium nitrate, lithium sulfate, or a mixture of salts. In one embodiment, ion exchange occurs when a mixture containing a mixture of lithium nitrate and lithium sulfate is placed in contact with the glass surface at a temperature exceeding 400° C.

In other embodiments, lithium is included in at least one of the surfaces by implanting lithium ions into the surface of the glass. In still other embodiments, a layer of lithium metal can be deposited on the glass surface by, for example, using evaporation or sputtering processes. According to other embodiments, lithium may be included on one of the surfaces by adsorbing a liquid mixture containing lithium ions onto at least one of the surfaces prior to the step of placing the surfaces in contact. In still other embodiments, lithium may be included on one of the surfaces by coating one of the surfaces with a sol-gel layer containing lithium ions.

The methods of the present invention are useful for bonding a wide variety of surfaces and articles. The invention can be used to bond optical components including but not limited to optical fibers, optical ferrules, lens arrays, planar waveguides, gratings, amplifiers, filters, prisms, polarizers, birefringent crystals, faraday rotators and lenses. The methods can be used to bond surfaces that have different refractive indices or different coefficients of thermal expansion. The method is particularly useful for bonding glass articles together, wherein lithium is included at the bonding interface between the glass articles. The bonding interface typically includes surface portions of the articles. In certain embodiments, a surface portion of at least one of the articles is contacted with a solution having a pH greater than 8. Examples of solutions having a pH greater than 8 are hydroxide solutions such as ammonium hydroxide. In some embodiments, termination groups are provided on the surface portion of at least one of the articles. Examples of termination groups include —OH, ≡Si—OH, ═Si—(OH)₂, —Si—(OH)₃ and —O—Si—(OH)₃, and combinations thereof. In still other embodiments a hydrophilic surface can be provided on a surface portion of at least one of the articles. In some embodiments, a surface portion of at least one of the articles is contacted with an acid.

The invention provides a simple, low temperature and reliable bonding method that provides increased bond strength with silicon-containing articles by including lithium in the surface portion of at least one of the articles. While not wishing to be bound by a particular theory of operation, lithium has been observed to migrate between the surfaces when in contact at temperatures below 100° C. to form a very strong seal between the surfaces. In embodiments in which the methods are used to bond optical articles an optically clear bond between optical components is provided. Bonding can occur at temperatures lower than the softening or deformation temperature of the articles, and in some embodiments lower than 100° C. Additional advantages of the invention will be set forth in the following detailed description. It is to be understood that both the foregoing general description and the following detailed description are exemplary and are intended to provide further explanation of the invention as claimed.

### DETAILED DESCRIPTION

Copending, commonly assigned United States patent application Ser. No. 10/035,564 filed on Oct. 26, 2001, entitled “Direct Bonding of Articles Containing Silicon” and naming Robert Sabia as inventor, discloses improved methods of directly bonding silicon-containing and glass articles. Further experimentation in the area of direct bonding has led to the discovery that bonding can be improved by including lithium in or on the surface of the articles to be bonded, or by incorporating lithium in the composition of the articles.

While the present invention should not be limited by a particular theory of operation, applicants presently offer the following understanding as to why the addition of lithium to surfaces by either a deposited layer and/or adding lithium to the composition of one of the surfaces improves low temperature sealing bonding. Lithium is one of the most mobile ions and readily migrates within a solid material such as glass at temperatures below 100° C. This behavior is due to the lithium ion's size, charge, and diffusion constant. Migration is a diffusion process, which is inconsequential for materials of homogeneous composition where bulk migration of one component does not result in a compositional gradient. In other words, as one lithium ion in a homogeneous material migrates from point A to point B, another statistically, will migrate from point B to point A.

However, by coating a surface with lithium and/or including lithium in or on a surface, a physical compositional gradient is generated, which with heating will allow for bulk diffusion of lithium away from the lithium rich area into the lithium deficient area. When surfaces (one or both) containing lithium are brought into contact and heated, lithium will migrate across the interface from one surface to another, thus generating covalent bonds between the surfaces. If a gradient exists in terms of lithium concentration between the two surfaces, lithium will migrate from the lithium rich surface into the lithium poor surface, mostly without exchange for less mobile ions such as sodium or potassium. If a layer of lithium metal or oxide is placed on one surface prior to contacting the surfaces and heating, lithium will diffuse from the layer into each surface.

Direct chemical bonding relates to the process of generating high strength bonds between surfaces at relatively low temperature, for example, less than about 200° C. without the use of polymeric adhesives or a vacuum. In short, surfaces are cleaned and placed in contact with little or no applied force and moderately heated to generate the seal. Because surfaces in this process are heated to temperatures greater than about 100° C., absorbed water is removed from between the surfaces and hydrogen bonding between surface groups generates a bond. For glass compositions containing greater than about 95% by weight silica, this sealing temperature is sufficient to allow for bond strengths that will not delaminate. However, for glass compositions containing between about 50% and 95% silica by weight, this chemical bonding process typically yields bond strengths between about 10-30 pounds per square inch, with bond failure typically occurring by delamination. For higher bond strengths, the bonding process is typically followed by an annealing cycle to temperatures up to about 600° C., thus converting hydrogen bonds to covalent bonds. Such annealed seals do not fail by delamination, but rather fail by fracture of the bulk glass away from the seal, with fracture strengths typically between about 100-200 pounds per square inch. However, such anneal cycles are not practical for applications when low temperature materials (e.g., optical fiber coatings and adhesives) are incorporated into a surface structure.

Initial experiments involving the bonding of Pyrex® surfaces revealed that low bond strengths were achieved. Pyrex® contains about 81 weight percent silica, and it is a standard material used in the manufacture of photonic components including optical fiber ferrules. According to some embodiments of the invention, bond strength in Pyrex® and other materials is improved by including lithium in or on at least one of the surfaces prepared for bonding. Lithium can be included in or on the surfaces by various methods. For example, lithium can be exchanged, deposited, or implanted into surfaces prepared for bonding, thus allowing chemical bonding to become directly feasible for applications where glass or silicon-containing materials having poor bond strength. Furthermore, in certain embodiments, novel glass compositions incorporate lithium for specific applications where chemical bonding is to be used.

Experiments have confirmed that Pyrex® glass articles will not generate a strong bond without a subsequent anneal up to temperatures exceeding about 400° C. Rather, Pyrex® surfaces sealed at about 200° C. were found to delaminate at loads lower than about 20 pounds per square inch. In comparison, equivalent bonding of high purity fused silica (HPFS®) and Fotoform® surfaces without a subsequent high temperature anneal resulted in failure by glass fracture above 125 pounds per square inch. While the present invention should not be limited by any particular theory, lithium migration between Fotoform® surfaces was hypothesized to be the mechanism for stronger bonding over Pyrex® surfaces, because Pyrex® does not contain lithium. Both Fotoform® and Pyrex® are complex silicate glasses that include large concentrations of alkalis.

According to some embodiments of the invention, Pyrex® seal strengths are increased to greater than about 90 PSI by ion exchanging lithium for sodium in the surface of glass articles prior to bonding. The seals do not require a post-bonding anneal to generate higher seal strengths, thus allowing for bonding of complex systems that include polymeric coatings and adhesives that degrade above about 150 to 200° C. Failure occurred by glass fracture rather than by delamination.

Other embodiments of the invention involve sealing of lithium containing glasses or glass-ceramics, where both surfaces contain lithium. One particular example of such an application involves sealing of fiber arrays made from Fotoform® glass, which is available from Coming, Inc. to microlens arrays made from Fotoform Opal® or Fotoceram®, also available from Coming, Inc. Still other embodiments of the invention relate to sealing or bonding of two surfaces where one surface is a lithium-containing glass or glass-ceramic and the other surface does not include lithium. A specific example of such an application involves sealing of fiber arrays to microlens arrays where one component is either Fotoform®, Fotoform Opal®, or Fotoceram® and the other is a high purity fused silica product such as HPFS®, available from Coming, Inc.

In other embodiments, sealing or bonding of glass surfaces containing alkalis is achieved by incorporating lithium into the glass surfaces by an ion exchange process. One example of this type of process involves fibers mounted in fiber ferrules made from Pyrex® glass that have been ion-exchanged with lithium and subsequently bonded. In still other embodiments, lithium can be included in glass surfaces that contain little or no alkali by utilizing lithium ion implantation. After ion implantation, the surfaces including lithium can be bonded. Other embodiments involve the incorporation of lithium into the manufacturing of novel glass and glass-ceramics for chemical bonding applications.

According to some embodiments of the present invention, bonding between a wide variety of articles can be improved by including lithium on or in the surface of at least one of the articles to be bonded. Examples of such articles include conventional glass articles, electronic components and optical articles. The optical articles, can include, but are not limited to, an optical waveguide, a planar waveguide, an optical waveguide fiber, a lens, a prism, a grating, a faraday rotator, a birerfringent crystal, a filter, a polarizer to an optical component. As used herein, the terms “direct bonding” and “direct bond” means that bonding between two surfaces is achieved at the atomic or molecular level, no additional material exists between the bonding surfaces such as adhesives, and the surfaces are bonded without the assistance of fusion of the surfaces by heating. As used herein, the terms “fusion” or “fusion bonding” refers to processes that involve heating the bonding surfaces and/or the material adjacent the bonding surfaces to the softening or deformation temperature of the articles bonded. The methods of the present invention do not involve the use of adhesives or fusion bonding to bond optical components. Instead, the present invention utilizes methods that involve forming a direct bond between the surfaces without high temperatures that soften the glass material to the point of deformation or the softening point and which typically results in an interface that is not optically clear. The present invention provides a bonding method that provides an impermeable, optically clear seal, meaning that there is essentially zero distortion of light passing between the interface of the bonded surfaces. The formation of a direct bond between two glass, crystalline or metal surfaces allows for an impermeable seal that has the same inherent physical properties as the bulk materials being bonded.

According to certain embodiments of the invention, termination groups are provided on opposing surfaces of the articles to be bonded. No adhesives, high temperature treatment or caustic hydrofluoric acid treatments are required prior to bonding the opposing surfaces. In some embodiments of the invention, a surface treatment of a high pH base mixture such as sodium hydroxide, potassium hydroxide or ammonium hydroxide is utilized to provide termination groups on the bonding surfaces of the articles. In certain embodiments, the surfaces are first cleaned using a detergent followed by rinsing with an acid solution such as a nitric acid solution to remove particulate contamination and soluble heavy metals respectively.

According to some embodiments of the invention, the surfaces are contacted with a high pH solution, rinsed, pressed into contact and gradually heated to the desired temperature, preferably to a temperature less than about 300° C. To enhance bonding, it is preferred that the surfaces are flat, as determined by performing a preliminary cleaning and pressing the dried samples into contact.

In preferred embodiments, the bonding process includes machining each surface to be sealed to an appropriate flatness. Particularly preferred flatness levels are less than about 1 micron and roughness levels of less than about 2.0 nm RMS. After polishing, lithium ions can be exchanged into glass surfaces containing alkali ions by contacting the surface of the glass with a mixture containing lithium ions. Such a mixture could include a particular lithium salt or mixture of lithium salts. For example, a 1:5 ratio mixture of lithium sulfate and lithium nitrate could be used to soak the surface prepared for bonding. In certain embodiments, it may be desirable to heat the mixture during soaking to a temperature of about 500° C. and to soak the surface for about 16 hours. Thereafter, depending on the roughness of the surface after ion exchange, it may be desirable to re-polish the surface to about 100 nm RMS. After polishing, each surface is preferably cleaned with an appropriate cleaning solution such as a detergent, soaked in a low pH acidic solution such as 10 volume percent nitric acid, rinsed, and soaked in a high pH basic solution such as a 15 volume percent ammonium hydroxide solution to generate a clean surface with silicic acid-like (i.e., ≡Si—OH, ═Si—(OH)₂, —Si—(OH)₃ and —O—Si—(OH)₃) terminated surface groups. In a preferred embodiment, the surfaces are assembled without drying. A low to moderate load (as low as 1 PSI) is then applied as the surfaces are heated to less than 300° C., for example, between 100-200° C., so that absorbed water molecules evaporates and silicic acid-like surface groups condense to form a covalently-bonded interface. Pressure can be applied using various fixturing devices that may include the use of compressed gas or a low vacuum pressure that is not detrimental to polymers. In some embodiments, it may be acceptable to moderately dry the bonding surfaces to remove absorbed water molecules, especially when using a low vacuum (e.g., about 10⁻³ millibar) to assist in sealing the bonding surfaces without an air gap.

According to some embodiments of the invention, it is desirable to provide bonding surfaces that are flat. It is preferred to have surfaces finished to about 2 microns flatness or better, and preferably about 0.5 micron flatness or better, on the surfaces to be bonded.

For glass surfaces having a high percentage of silica, higher temperature heating is not necessarily required to form high strength bonds. For higher silica systems, heating below 300° C. is usually sufficient to form a high strength bond. On the other hand, samples that have a lower amount of silica in the glass composition may require heating to higher temperatures to form a satisfactory bond. For example, Pyrex® glass (containing approximately 81% silica) and Polarcor™ (containing approximately 56% silica), which are borosilicate glasses, may require additional heating to provide sufficient bond strength for applications requiring high bond strength. The degree of heating for different bonding surfaces and glass surfaces will depend in part on the type of surface to be bonded (e.g., a fiber or a flat surface) and the desired bond strength for a particular application. In systems that include polymeric materials, such as optical fiber waveguides, it is undesirable to heat the surfaces to the point where the polymeric material is damaged.

Details on the bond strength and additional information on a preferred embodiment of chemically bonding glass surfaces may be found in copending United States patent application entitled, “Direct Bonding of Articles Containing Silicon,” commonly assigned to the assignee of the present patent application and naming Robert Sabia as inventor. However, the present invention is not limited to the chemical bonding methods disclosed in the copending patent application and other chemical bonding techniques can be utilized in accordance with the present invention.

Ion exchange will occur when lithium diffuses into a silicon-based glass containing other alkali additives. Lithium will diffuse into the surface, while the ion lithium is exchanging for will more towards the bulk surface. In one experiment where lithium (from a lithium nitrate/sulfate mixture) was ion exchanged for sodium in Pyrex® glass at about 500° C. for about 16 hours. Because the surface crazed and therefore degraded past the minimal flatness and roughness required for sealing, the surfaces were re-polished while only removing a shallow depth of material while still ensuring that lithium existed in the re-polished surface. Results for sealing of these samples at a temperature of about 200° C. without a subsequent anneal or heat treatment at a higher temperature showed an increase in seal strength as determined by tensile testing and seal failure by fracture rather than delamination.

Another way of including lithium in or on the surface of an article to be bonded is by ion implantation. Lithium ion implantation relates to the diffusion or implantation of lithium into a pure material, for example, a high purity fused silica glass. Because there is no ion to exchange with, the depth and speed in which lithium may diffuse into the surface are limited. By using this process, high purity fused silica can be bonded or sealed to a lower silicate-based glass. Because lithium will more readily diffuse into the latter, lithium is first implanted into the high purity fused silica, and then allowed to diffuse across the interface during sealing or bonding, thus assisting in the formation of covalent bonds between surfaces. It is hypothesized that the mechanism for improved sealing or bonding performance at lower temperatures is due to the removal of water product from condensation away from the interface and into the bulk glass, together with lithium migration between the surfaces.

The above example for ion exchange included the use of a lithium-based molten salt. However, an alternative way of including lithium on or in a surface in preparation for ion exchange or implantation is to deposit a solid layer of lithium metal. Methods including, but not limited to evaporation, such as thermal or e-beam evaporation and sputtering can be used to deposit lithium metal. The lithium metal will oxidize as soon as it is removed from the vacuum deposition chamber, but this does not adversely affect lithium diffusion, and thus bonding is not adversely affected. Other potential methods for coating surfaces with lithium are include adsorption of lithium ions from a liquid mixture onto one or both surfaces after cleaning and just before assembly of interfaces for sealing or bonding. Also, one or both surfaces could be coated with a lithium-based silicate sol-gel layer. This layer would be very thin, and after condensation, this layer would be a physical extension of the surface. A thin layer allows migration of deposited lithium into one or both surfaces, thus eliminating physical and optical barriers that might exist if a distinct metal layer was present after sealing. The thickness of this layer will depend on many factors including the composition of the glasses being sealed, sealing temperature, and thermal treatments implemented between film deposition and sealing.

There are numerous specific applications where certain embodiments of the invention can be used, especially when the articles to be bonded cannot be annealed to just below the softening temperature of one or both of the materials. One of these applications involves the sealing or bonding of two thin parts. Bonding or sealing of two thin parts is complicated by the fact that thin parts having a uniform thickness are typically not flat due to stress induced warping from grinding and polishing, which is referred to as the “Twyman effect”. When sealing or bonding these parts, pressure applied to both parts forces both the surfaces together and sealing does occur at the interface, however, after the pressure is removed the stress remains. Further complicating this matter is that since the parts are thin, they will elastically deform and flex. In other words, the same property that enables the two, non-flat interfaces to be pressed together for sealing, also counteracts the bond and reduces seal strength when the seal is mechanically tested. Experiments showed that two HPFS® articles bonded together at about 200° C. results in an interface that will not delaminate, unless the parts are so thin (less than about 2 mm thick each) that mechanical testing causes the parts to flex and thus pry apart and delaminate. Such delamination has been observed with 0.5 mm thick Polarcor™ pieces that did not survive dicing into smaller samples after bonding or sealing. Improved seal strength was attained for the Polarcor™ samples by thermally depositing lithium onto one sample surface and repeating identical bonding procedures, resulting in a sealed surface that survived dicing. Further experiments showed that the sealing process could be repeated at temperatures below 100° C. while still achieving a sufficiently strong seal to survive dicing operations.

In the semiconductor industry, vacuum bonding of silicon wafers that must be subsequently diced have similar problems. These problems are avoided by heating the sealed wafers to temperatures exceeding 1000° C. and producing a fusion bond. There are many applications that will not allow heating to those high annealing temperatures necessary to promote strong interface seals; e.g., components that include polymers that are not stable at or will not survive high temperatures. Incorporation of lithium in or on at least one of the surfaces to be bonded allows surfaces to be bonded at lower temperatures.

The present invention is also useful in bonding or sealing of two dissimilar materials that have significantly different coefficients of thermal expansion (CTE). Stress between the two surfaces due to the difference in CTE can and typically does prevent the formation of a strong bond when the surfaces have to be annealed to achieve the bond or seal. The present invention allows the bond or seal to be formed without using high temperatures, more specifically at temperatures below 100° C.

Another particular application in which the present invention can be utilized is in bonding or sealing of surfaces with significantly different refractive indexes (RI), where the sealed interface is part of the optical path. Typically, an anti-reflection (AR) coating between the surfaces is required, with most AR coatings being at least three layers of different RI materials. These various AR coating materials have significantly different CTE values, and therefore, the use of high temperature annealing treatments to form a bond or seal can cause stress between the bonded surfaces and loss of bond strength. Bonding or sealing can be accomplished between two deposited or grown silica outer AR coating layers (one on each surface to be bonded) or between and AR coated surface and the base-glass composition of the second material. By adding lithium to the outermost surface of the article to be bonded, high temperature annealing is not required, resulting in a bond or seal that does not include a stressed bond interface. By designing the AR coating for the differences in refractive index between the materials being bonded, only one surface needs to be coated, and sealing with lithium can be successful if the outer AR coating layer is silica. To effect sealing of a silica outer layer to a low silica composition glass, lithium can be deposited first on the silica coating such that diffusion readily progresses across the interface by ion exchange with alkali in the opposite seal side.

Without intending to limit the invention in any manner, the present invention will be more fully described by the following examples.

### EXAMPLES 1 AND 2

Sample Preparation

For each of the samples listed in Table I below, the surfaces were bonded at a temperature of about 200° C. Prior to sealing of the surfaces, they were polished to less than about 0.5 microns flatness, and the samples were cleaned in accordance with the procedures in the copending patent application entitled “Direct Bonding of Articles Containing Silicon,” commonly assigned to the assignee of the present application and naming Robert Sabia as inventor. More particularly, a detergent such as Microclean CA05 was used to clean the samples, and after a water rinse, the sample was soaked in 10 volume % nitric acid for one hour. The acid-soaked samples were rinsed again with water, and then the samples were soaked in a 15 volume % ammonium hydroxide solution for 60 minutes. The samples were rinsed again, and the bonding surfaces were maintained in a wet condition and bonded under a pressure greater than about one pound per square inch and at a temperature noted above. The results are shown in Table I below.

TABLE I
The table lists fracture behavior of chemically bonded surfaces tested
in tension, with all seals generated at 200 ± 5° C. with no subsequent
annealing cycle. Strength values given for bonds that failed by glass
fracture do not represent the bond strength upper limit, but instead indicate
that failure occurred away from the seal interface at the indicated load due
to a structural flaw in the bulk material.

| Sealed Surfaces | | Bond strength | Fracture Behavior |
|---|---|---|---|
| 1 | Pyrex ® to Pyrex ® | 16.4 PSI | Delamination |
| 2 | Li Implanted Pyrex ® to | 92.8 PSI | Glass Fracture |
| | Li Implanted Pyrex ® | | |
| 3 | Fotoform ® to Fotoform ® | 128.8 PSI | Glass Fracture |
| 4 | Fotoform ® to Fotoform | 204.5 PSI | Glass Fracture |
| | Opal ® | | |
| 5 | Fotoform Opal ® to Fotoform | 151.7 PSI | Glass Fracture |
| | Opal ® | | |

Lithium oxide was placed in the surface of the Li Implanted Pyrex^{â} sample by soaking the Pyrex^{â} samples in a solution of lithium sulfate and lithium nitrate (the ratio of lithium sulfate to lithium nitrate was 1:5) at 500° C. for 16 hours. Fotoform®, like Pyrex® is a low silica glass, i.e., a glass that contains less than approximately 80% silica. Fotoform® contains approximately 9.7% lithium oxide, and Pyrex® does not contain any lithium oxide. Fotoform Opal® is a Fotoform® glass that has been cerammed to a glass-ceramic. The results in Table I show that all of the samples that contained lithium had a bond strength that was higher than the glass fracture strength of the bulk material. The Pyrex® samples, which did not have lithium in the surface or the bulk of the glass, failed at the seal by delamination. These results indicate that including lithium in at least a surface portion of a glass or glass-ceramic article will improved bond strength between the articles. Bond strength can be improved by including lithium in the surface by implantation of lithium or by incorporating lithium into to the bulk composition of the glass or glass ceramic article.

The use of lithium to improve bond strength has several advantages. Lithium can diffuse at temperatures below 100° C., thus promoting a low-temperature bonding processes. Experimental results did not indicate that this low temperature effect occurred with any other alkali ion. Another advantage of the present invention is that lithium in small amounts will not interfere with optical properties of glasses. Therefore, using lithium to generate a seal or bond that is part of an optical path is not detrimental to optical performance. Still another advantage of some embodiments of the present invention is that lithium can be ion exchanged or implanted into virtually any silica-based glass composition. Additionally, lithium can be used to promote and/or improve bonding between materials with significantly different coefficient of thermal expansion (CTE) values by promoting sealing at lower-than-normal temperatures (below about 100° C. in less than 24 hours). Lithium can be used to promote low temperature bonding between anti-reflectance coatings on materials with significantly different RI.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. A method of bonding at least two surfaces, one of the surfaces including silicon, comprising the steps of:
including lithium on at least a portion of one of the surfaces; and
placing the surfaces directly in contact in the absence of an adhesive and at a temperature below the softening point of the surfaces.

2. The method of claim 1, wherein at least one of the surfaces includes a glass.

3. The method of claim 2, wherein the bond strength between the surfaces exceeds 90 pounds per square inch.

4. The method of claim 1, wherein the temperature during the contacting step is below 400° C.

5. The method of claim 2, wherein lithium is incorporated in the composition of the glass.

6. The method of claim 2, wherein the glass surface includes alkali elements.

7. The method of claim 6, further including the step of exchanging lithium ions with alkali ions prior to the step of placing the surfaces in contact.

8. The method of claim 1, wherein the surfaces have different refractive indices.

9. The method of claim 7, further including the step of contacting the glass surface with a mixture containing lithium.

10. The method of claim 9, wherein the mixture includes a lithium salt.

11. The method of claim 10, wherein the mixture includes lithium nitrate.

12. The method of claim 11, wherein the mixture includes lithium sulfate.

13. The method of claim 12, wherein the mixture is placed in contact with the glass surface at a temperature exceeding 400° C.

14. The method of claim 2, further including the step of implanting lithium ions on the surface of the glass.

15. The method of claim 2, further including the step of depositing a layer of lithium metal on the glass surface.

16. The method of claim 15, wherein the lithium metal is deposited by an evaporation process.

17. The method of claim 15, wherein the lithium metal is deposited by a sputtering process.

18. The method of claim 2, further including the step of adsorbing a liquid mixture containing lithium ions onto at least one of the surfaces prior to the step of placing the surfaces in contact.

19. The method of claim 2, further including the step of coating one of the surfaces with a sol-gel layer containing lithium ions.

20. The method of claim 2, wherein the surfaces have different refractive indices.

21. The method of claim 2, wherein the surfaces have different coefficients of thermal expansion.

22. A method of bonding at least two glass articles together comprising the steps of:
providing a bonding interface between the glass articles; and
including lithium at the bonding interface.

23. The method of claim 22, wherein the bonding is performed in the absence of an adhesive and at a temperature below 200° C.

24. The method of claim 22, wherein the bonding interface includes a surface portion of at least one of the articles.

25. The method of claim 24, wherein lithium is incorporated in the composition of the surface portion of at least one of the articles

26. The method of claim 22, wherein the surface portion of at least one of the glass articles includes alkali elements.

27. The method of claim 26, further including the step of exchanging lithium ions for alkali ions.

28. The method of claim 26, wherein the surface is contacted with a mixture containing lithium.

29. The method of claim 28, wherein the mixture includes lithium sulfate and lithium nitrate.

30. The method of claim 24, further including the step of implanting lithium ions in the surface portion of at least one of the glass articles.

31. The method of claim 24, further including depositing a layer including lithium on a surface portion of at least one of the glass articles.

32. The method of claim 24, further including the step of contacting the surface portion of at least one of the articles with a mixture having a pH greater than 8.

33. The method of claim 32, further including the step of providing termination groups on the surface portion of at least one of the articles selected from the group consisting of —OH, ≡Si—OH, ═Si—(OH)₂, —Si—(OH)₃ and —O—Si—(OH)₃, and combinations thereof.

34. The method of claim 32, wherein the mixture includes a hydroxide.

35. The method of claim 34, wherein the mixture includes ammonium hydroxide.

36. The method of claim 24, further including the step of providing a hydrophilic surface on the surface portion of at least one of the articles.

37. The method of claim 34, further including the step of contacting the surface portion of at least one of the articles with an acid.
